(19) United States
(12) Patent Application Publication
(10) Pub. No.: US 2025/0390089 A1
(43) Pub. Date: Dec. 25, 2025

(54) METHOD, APPARATUS, SYSTEM AND MEDIUM FOR ANOMALY DETECTION IN INDUSTRIAL NETWORKS

(71) Applicant: ABB SCHWEIZ AG, Baden (CH)

(72) Inventors: Jijun Ma, Hangzhou (CN); Yu Liu, Hangzhou (CN); Hongke Zhang, Hangzhou (CN)

(21) Appl. No.: 19/314,863

(22) Filed: Aug. 29, 2025

Related U.S. Application Data
(63) Continuation of application No. PCT/CN2024/073909, filed on Jan. 24, 2024.

(30) Foreign Application Priority Data
Mar. 23, 2023 (CN) 202310295177.8

(51) Int. Cl. G05B 23/02

(52) U.S. Cl. CPC G05B 23/024; G05B 23/027; G05B 23/0286

(57) ABSTRACT

Embodiments of the present disclosure provide a method, an apparatus, a system and a computer readable storage medium for anomaly detection in an industrial network. The method includes, according to an industrial network protocol, extracting contents of a plurality of fields in a plurality of packets in the industrial network. The method further includes generating, based on the extracted contents of the plurality of fields, a plurality of feature values corresponding to the plurality of packets. In addition, the method includes converting a time series representing the plurality of feature values and a plurality of moments corresponding to the plurality of feature values into a bitmap image. The method also includes detecting, based on the bitmap image, an abnormality in the industrial network. Through the embodiments of the present disclosure, it can be achieved to more easily and more accurately identify an abnormality occurring in an industrial network.

### CROSS REFERENCE TO RELATED APPLICATIONS

This application claims priority to CN. application No. 202310295177.8, filed Mar. 23, 2023, and titled “METHOD, APPARATUS, SYSTEM AND MEDIUM FOR ANOMALY DETECTION IN INDUSTRIAL NETWORKS”, the disclosure of which is incorporated herein by reference in its entirety.

### FIELD

Embodiments of the present disclosure generally relate to the field of computers, and more specifically, to a method, an apparatus, a system and a computer readable storage medium for anomaly detection in an industrial network.

### BACKGROUND

With the development of digital technology, the Industrial Internet of Things (IIoT) emerges. It is continuously developing and can improve the industrial operation efficiency. However, as a smart industrial product is connected to the global network, there is a growing demand for cost-effective and standards-based technologies (e.g. the Ethernet and TCP/IP). These Internet-based networks are more vulnerable to cyberattacks. Therefore, it is of great significance to establish an industrial network security architecture for an industrial system.

Nevertheless, an industrial system has different requirements for network security than an Internet information technology system. The industrial network requires a higher reliability, and there exist a variety of industrial network protocols. The existing intrusion prevention systems in the industrial network have problems of a low anomaly detection rate, a low accuracy, a high false alarm, a poor real-time attack performance and the like.

### SUMMARY

Embodiments of the present disclosure provide a method, an apparatus, an electronic device and a computer readable storage medium for anomaly detection in an industrial network.

In a first aspect of embodiments of the present disclosure, there is provided a method for anomaly detection in an industrial network. The method comprises, according to an industrial network protocol, extracting contents of a plurality of fields in a plurality of packets in the industrial network, wherein the plurality of packets is generated based on data collected from a sensor. The method also comprises generating, based on the extracted contents of the plurality of fields, a plurality of feature values corresponding to the plurality of packets, wherein the contents at least comprise an industrial protocol identifier and an industrial message type. In addition, the method comprises converting a time series representing the plurality of feature values and a plurality of moments corresponding to the plurality of feature values into a bitmap image. The method also comprises detecting, based on the bitmap image, an abnormality in the industrial network.

In a second aspect of the present disclosure, there is provided an apparatus for anomaly detection in an industrial network. The apparatus comprises a content extraction module configured to extract, according to an industrial network protocol, contents of a plurality of fields in a plurality of packets in the industrial network, wherein the plurality of packets is generated based on data collected from a sensor. The apparatus further comprises a feature value generation module configured to generate, based on the extracted contents of the plurality of fields, a plurality of feature values corresponding to the plurality of packets, wherein the contents at least comprise an industrial protocol identifier and an industrial message type. In addition, the apparatus comprises a bitmap conversion module configured to convert a time series representing the plurality of feature values and a plurality of moments corresponding to the plurality of feature values into a bitmap image. The apparatus also comprises an anomaly detection module configured to detect, based on the bitmap image, an abnormality in the industrial network.

In a third aspect of the present disclosure, there is provided a system for an industrial network. The system comprises a sensor for collecting data of industrial devices in the industrial network. The system further comprises an electronic device for receiving the data from the sensor, which is located in a cloud or an industrial site, wherein the electronic device comprises: a processor; and a memory coupled to the processor, the processor having instructions stored therein, the instructions, when executed by the processor, causing the electronic device to implement the method of the first aspect.

In a fourth aspect of the present disclosure, there is provided a computer readable storage medium having computer executable instructions stored thereon, wherein the computer executable instructions, when executed, cause a device to implement the method of the first aspect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other features, advantages and aspects of respective embodiments of the present disclosure will become more apparent, through the following detailed description with reference to the accompanying drawings. Throughout the drawings, the same or similar reference symbols refer to the same or similar components, where:

FIG. 1 illustrates a schematic diagram of an example environment where embodiments of the present disclosure can be implemented;

FIG. 2 illustrates a schematic diagram of a system for anomaly detection in an industrial network according to example implementations of the present disclosure;

FIG. 3 illustrates a flowchart of a method for anomaly detection in an industrial network according to example implementations of the present disclosure;

FIG. 4 illustrates a process of converting packets in an industrial network into a time series according to example implementations of the present disclosure;

FIG. 5 illustrates a process of converting a time series into two-dimensional coordinates according to example implementations of the present disclosure;

FIG. 6 illustrates a process of converting two-dimensional coordinates into a bitmap image according to example implementations of the present disclosure;

FIG. 7 illustrates a schematic diagram of an internal structure of an anomaly detection model according to example implementations of the present disclosure;

FIG. 8 illustrates a block diagram of an apparatus for anomaly detection in an industrial network according to example implementations of the present disclosure;

FIG. 9 illustrates a block diagram of a device for anomaly detection in an industrial network according to example implementations of the present disclosure.

Throughout the drawings, the same or similar reference symbols refer to the same or similar components.

### DETAILED DESCRIPTION OF EMBODIMENTS

Reference now will be made to the drawings to describe embodiments of the present disclosure in detail. Although some embodiments of the present disclosure are depicted in the drawings, it would be appreciated that the present disclosure could be implemented in various forms, and should not be construed as being restricted to those illustrated herein. Rather, those embodiments are provided to enable those skilled in the art to understand the present disclosure more thoroughly and completely. It is to be understood that the drawings and embodiments are provided only as examples, without suggesting any limitation to the protection scope of the present disclosure.

In the following description about the embodiments, the term “includes” and similar expressions are to be read as open terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless indicated otherwise. Other definitions, implicit or explicit, may be included below. Further, the specific numerical values included in the context are provided only as example to offer an aid in understanding, without any intention to limit the scope.

With the advent of industrial transformation, more and more production networks are adopting Internet of Things (IoT). Due to this trend, the traditional industrial systems not connected to the Internet are not transformed into “Smart Factory” and “Smart Manufacturing.” However, connecting the industrial system online imposes more threads of being attacked by malware and viruses. Intrusion Detection System (IDS) is a system to analyze the data packets and detect the potential attack activates.

Researches have found that there are multiple types of industrial protocols, and the general intrusion detection system for the Internet is less supportive of anomaly detection in an industrial network and thus not suitable for the industrial network. As compared with an Internet information technology system, an industrial system has different requirements for network security, which requires a higher reliability. As compared with the Internet protocols, industrial protocols have their own characteristics. For example, for an Internet application, HTTP and HTTPS protocols have become the unified application layer access protocols where, by means of the underlying TCP/IP protocol suite, a user can access the Internet via a browser while using DNS, an identity parsing service, to efficiently carry out search and location of a designated website, thus completing information acquisition. However, there is a wide variety of industrial protocols, which are fragmented and each encompass multiple application protocols therein. There lacks a unified identity parsing service similar to DNS, and the parsing service standards are also fragmented, which can be initiated by different organizations. Therefore, there is a need for an anomaly detection solution specific to industrial protocols.

In view of the above, embodiments of the present disclosure provide a solution for anomaly detection in an industrial network. The solution includes converting a plurality of packets generated into a time series according to the industrial network protocol, converting the time series into a bitmap image, and then performing anomaly detection using an Artificial Intelligence (AI) model, for example, detecting an abnormal behavior in an industrial network.

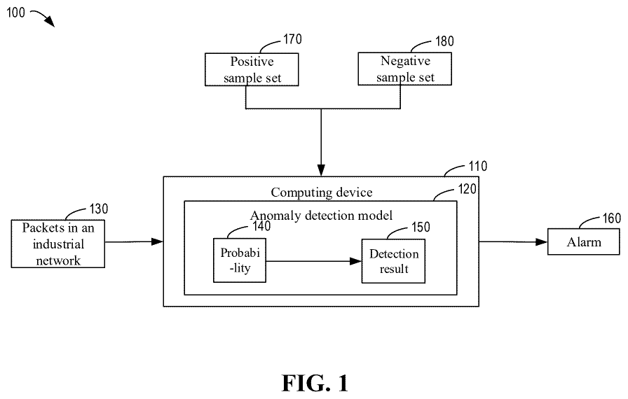

FIG. 1 illustrates a schematic diagram of an example environment 100 where embodiments of the present disclosure can be implemented. In the environment 100, a computing device 110 is included. The computing device 110 may be, for example, a computer system, a computing module, a server, an electronic device, and the like. The computing device 110 has an anomaly detection model 120 deployed therein. In some embodiments, the anomaly detection model 120 may be an AI model such as a deep learning model and the like. The anomaly detection model 120 can be obtained through training with a positive sample set 170 and a negative sample set 180.

In some embodiments, the positive sample set 170 may include a plurality of labelled bitmap images. Those bitmap images are generated from normal packets in an industrial network. The normal packets may refer to packets generated for data exchange between industrial devices, clients, servers and other devices in an industrial network. Those packets may indicate valid information such as sensor values, control instructions and the like. In some embodiments, the negative sample set 180 may include a plurality of labelled bitmap images. Those bitmap images are generated from abnormal packets in the industrial network. The abnormal packets may refer to fake packets, forged packets, a large number of packets repeatedly sent, and the like.

As shown in FIG. 1, the anomaly detection model 120 can receive a packet 130 in the industrial network. In some embodiments, the anomaly detection model 120 can receive a plurality of packets which are individually or collectively referred to as packet 130 in FIG. 1. Based on the received packet 130, the anomaly detection model 120 can determine a probability 140 that the packet 130 is a normal or abnormal packet. The anomaly detection model 120 or computing device 110 can determine whether a detection result 150 is normal or abnormal, based on a comparison between the probability 140 and a predetermined threshold.

If the detection result 150 is abnormal, the anomaly detection model 120 or computing device 110 may send an alarm 160. The anomaly detection model 120 or computing device 110 may also receive feedback on the alarm 160, for example, from an operator or client, wherein the feedback is, for example, whether the alarm 160 is correct or wrong.

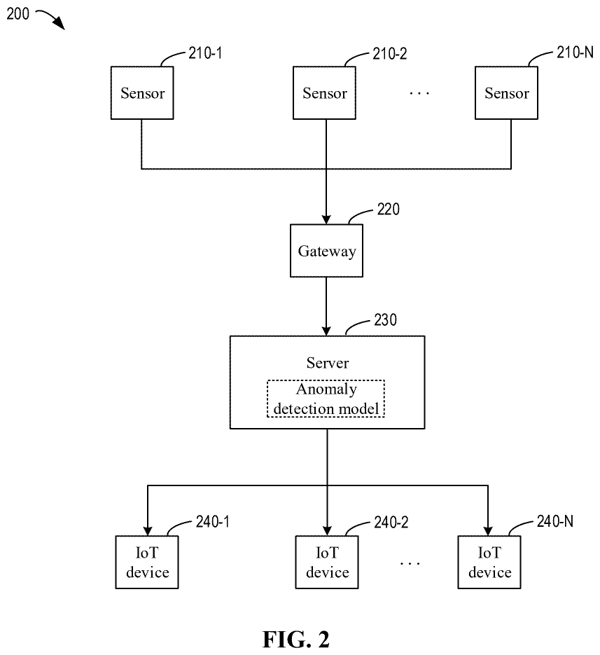

FIG. 2 illustrates a schematic diagram of a system 200 for anomaly detection in an industrial network according to example implementations of the present disclosure. As shown therein, the system 200 may include a sensor. It would be appreciated that the sensor may be provided in plural, for example, a first sensor 210-1, a second sensor 210-2 . . . an N^{th} sensor 210-N (individually or collectively referred to as sensor 210). The system 200 may also include a first IoT device 240-1, a second IoT device 240-2 . . . an N^{th} IoT device 240-N (individually or collectively referred to as IoT device 240).

The sensor 210 may be located in an industrial device (not shown), or may be mounted independently of the industrial device wherever needed, for example, at an industrial site. The sensor 210 can be connected to a gateway 220 via wired or wireless links, to send the collected data to the gateway 220. In some embodiments, the gateway 220 may have an anomaly detection model deployed therein. The gateway may aggregate data from a plurality of sensors, and further forward the data to a server 230. In some embodiments, the anomaly detection model may also be deployed in the server 230. In some embodiments, the server 230 may receive data from the sensor and make a decision. For example, the server 230 instructs an executor 240 to perform a corresponding act. By way of example, the executor 240 may be a valve. The corresponding act may be instructing the value to open or close. The server 230 may send other instructions to instruct the industrial device, the sensor 210 or the like to perform acts.

It would be appreciated that respective elements of the system 200 may be positioned at different locations. The respective elements of the system 200 may be connected remotely and wirelessly, different than those connected in a wired manner and positioned in the same location as shown in the figure. The server 230 may be a server in the cloud, and the gateway 220 is not a must.

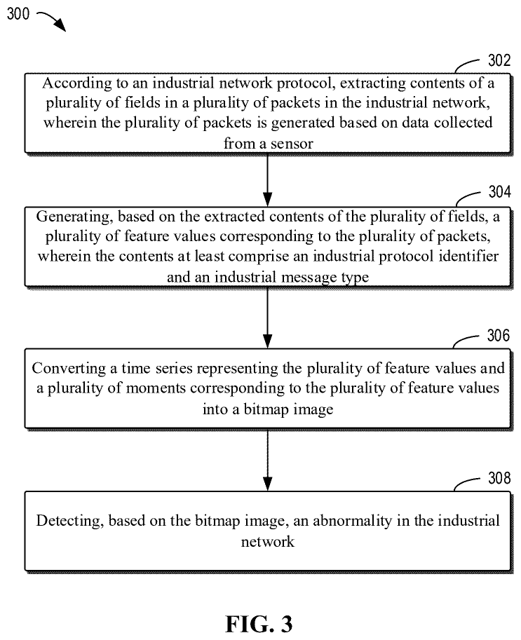

FIG. 3 illustrates a flowchart of a method 300 for anomaly detection in an industrial network. The method 300 may be performed by a computing device 110 in FIG. 1. The method 300 may be performed by a gateway 220 or server 230 in FIG. 2. At block 302, according to the industrial network protocol, contents of a plurality of fields in a plurality of packets in an industrial network are extracted, wherein the plurality of packets are generated based on data collected from the sensor.

By way of example, fields included in a packet A generated according to a certain industrial network protocol contain an industrial protocol identifier (ID) and an industrial message type. The content of the industrial protocol ID field is 1. The content of the industrial message type field is 10. Then, 1 and 10 can be extracted. For example, fields included in a packet B generated according to a certain industrial network contain an industrial protocol identifier (ID) and an industrial message type. The content of the industrial protocol ID field is 1. The content of the industrial message type field is 8. Then, 1 and 8 can be extracted.

At 304, a plurality of feature values corresponding to a plurality of packets are generated based on the extracted contents of the plurality of fields, wherein the contents at least include an industrial protocol identifier and an industrial message type. By way of example, for the packet A, an average of 1 and 10 can be taken as a feature value. For another example, a weighted average of 1 and 10 can be taken as a feature value, wherein weights can be 0.6 and 0.4. For the packet B, the situation is similar. Here, it is assumed that the feature value of the packet A is C, and the feature value of the packet B is D.

At 306, a time series representing a plurality of feature values and a plurality of moments corresponding to the plurality of feature values is converted into a bitmap image. By way of example, the time series may include a feature value C and a timestamp T1 of the packet A, and a feature value D and a timestamp T2 of the packet B. It would be appreciated that the time series may be a one-dimensional array. The time series is converted into a bitmap image, i.e., two-dimensional data pairs. At 308, an abnormality in the industrial network is detected based on the bitmap image. By way of example, whether the packet A or B is normal or abnormal can be detected based on the bitmap image. In some embodiments, a probability that a packet is abnormal can be predicted based on the bitmap image. If an abnormal probability is greater than a threshold, it can be determined that the packet is abnormal.

In this way, with the method 300, the present disclosure can provide anomaly detection specific to industrial networks and can specifically support industrial protocols. Embodiments of the present disclosure can enable more convenient and more accurate identification of an abnormality occurring in an industrial network environment while improving the reliability as required by the industrial network. In some embodiments, since the one-dimensional time series is converted into the bitmap image and then input into the deep learning model, through training and learning, the deep learning model can implement automatic extraction of abnormal features and automatic classification of network services, and the trained deep learning model has a robust generalization capability and can achieve a good classification effect, thereby providing a more accurate and quicker anomaly detection result.

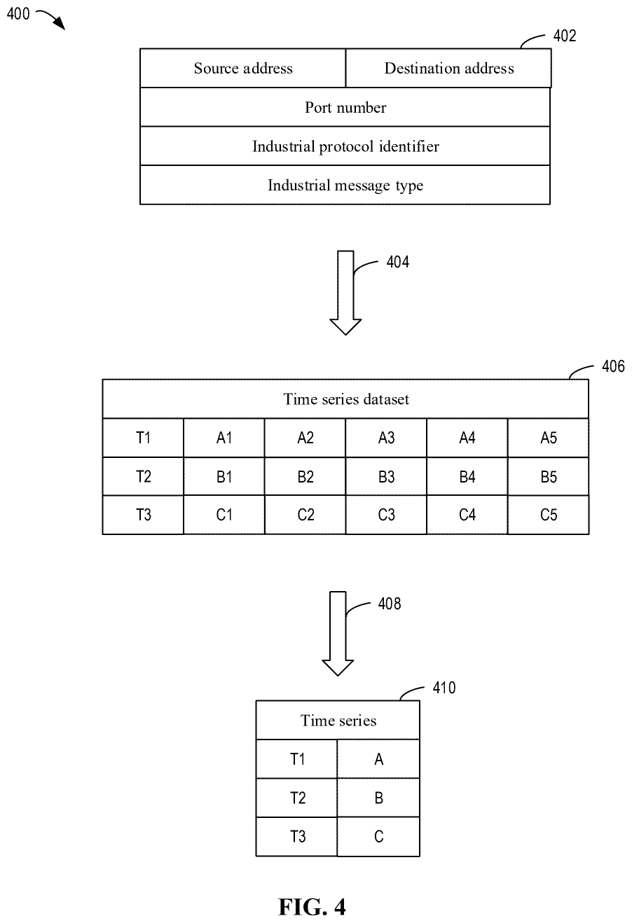

FIG. 4 illustrates a process 400 of converting packets in an industrial network into a time series according to example implementations of the present disclosure. The packet 402 may include (but is not limited to) the following fields: a source address, a destination address, a port number, an industrial protocol identifier and an industrial message type. In some embodiments, the packet 402 may also include a serial number, a message header, a security header, a signature and the like. For brevity, the structure of the packet 402 as shown is used herein to illustrate how the packets are converted into a time series.

Assumed that there are three packets having the same structure as the packet 402 and timestamps corresponding thereto are T1, T2 and T3, the contents of fields of the three packets are converted into a time series dataset 406 through extraction 404. In the time series dataset 406, the first row may correspond to the packet corresponding to the timestamp T1. A1 may represent the content of the source address. A2 may represent the content of the source address. A3 may represent the content of the port number. A4 may represent the content of the industrial protocol identifier. A5 may represent the content of the industrial message type. Likewise, in the time series dataset 406, the second row may correspond to the packet corresponding to the timestamp T2. B1 may represent the content of the source address. B2 may represent the content of the destination address. B3 may represent the content of the port number. B4 may represent the content of the industrial protocol identifier. B5 may represent the content of the industrial message type. The third row may correspond to the packet corresponding to the timestamp T3. C1 may represent the content of the source address. C2 may represent the content of the destination address. C3 may represent the content of the port number. C4 may represent the content of the industrial protocol identifier. C5 may represent the content of the industrial message type.

In some embodiments, the content of the field may be a number or identifier of the content, or the content of the field may be converted into a value within some ranges using some mapping rules. For example, the extracted content of the field of the port number 10 may be directly used, or 10 may be mapped into a numerical value in [0, 1] to represent the content of the field. In some embodiments, by weighting 408, each packet can be converted into a feature value. For example, Formula 1 may be used to convert the packet at the moment T1 into a feature value:

$$F = {w}_{1} * {F}_{1} + {w}_{2} * {F}_{2} + {w}_{3} * {F}_{3} + {w}_{4} * {F}_{4} + {w}_{5} * {F}_{5} \qquad ( 1 )$$

wherein F is the feature value, w₁ through w₅ are weights, and a sum of w₁ through w₅ is 1; F₁ through F₅ are contents of fields, for example, A1 through A5. It would be appreciated that, when a packet includes more fields, Formula (1) can be generalized to Formula (2):

$$F = {\sum }_{i = 1}^{n} {w}_{i} * {F}_{i} \qquad ( 2 )$$

wherein wᵢ is the weight, and Σᵢ₌₁ⁿwᵢ=1; Fᵢ is the content of the field; i is an integer; n is a total number of packets.

In this way, through weighting 408, a time series 410 can be obtained. In the time series 410, A is a feature value of a packet at the moment T1, B is a feature value of a packet at the moment T2, and C is a feature value of a packet at the moment T3. In some embodiments, the time series may be normalized to a value in the interval [0, 1]. In some embodiments, the total number (also referred to as first threshold) of packets may be set as required, and the steps in FIG. 4 are performed iteratively to generate a time series meeting the requirement. As such, with the process 400, various industrial protocol data can be converted into standardized time series data, to thus provide an accuracy for subsequent processing.

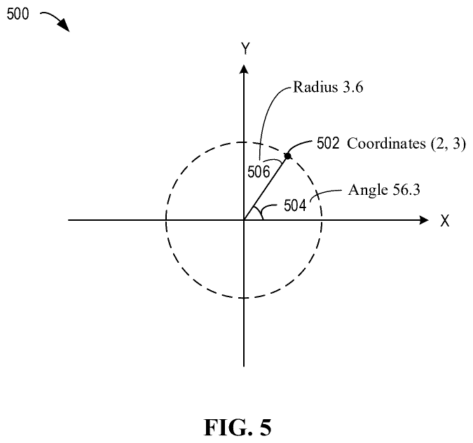

FIG. 5 illustrates a process 500 of converting a time series into two-dimensional coordinates according to example implementations of the present disclosure. As shown therein, in an XY coordinate system, there exists a point 502 with coordinates of (2, 3). The point 502 can be represented as further coordinates (3.6, 56.3) represented by a radius 506 and an angle 504. In some embodiments, the radius 506 can be obtained through computing with the coordinates (2, 3) of the point 502, for example, using the Pythagorean Theorem, i.e., the radius 506=\sqrt{2²+3²}=3.6.

In some embodiments, the angle 504 can be obtained through computing using an inverse trigonometric function (e.g. inverse cosine). That is,

$$504 = arc cos ( \frac{2}{3.6} ) = 56.3 ° .$$

In some embodiments, the angle 504 can be obtained using an inverse trigonometric function (e.g. arcsine), i.e.,

$$504 = arc sin ( \frac{3}{3.6} ) = 56.3 ° .$$

In this way, through the embodiments of the present disclosure, not only can complete information of time series signals be preserved, but also time-dependence thereof can be maintained.

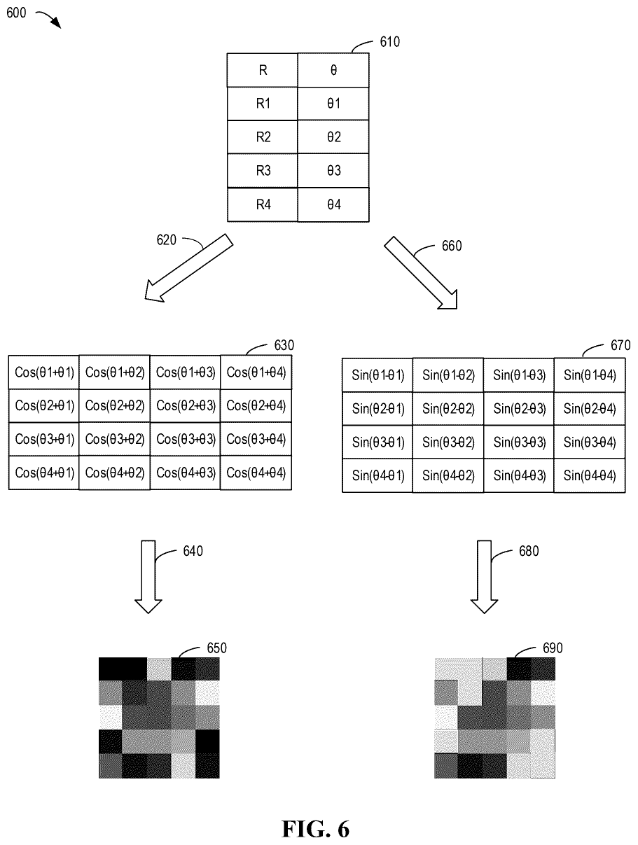

FIG. 6 illustrates a process 600 of converting two-dimensional coordinates into a bitmap image according to example implementations of the present disclosure. As shown therein, the two-dimensional coordinates 610 shows 4 pairs of two-dimensional coordinates (R1, θ1), (R2, θ2), (R3, θ3) and (R4, θ4), wherein R is a radius, and θ is an angle.

Conversion 620 shows converting the two-dimensional coordinates 610 into a bitmap images 650. Conversion 620 can be performed using the cosine of the sum of the angle values of each pair of two-dimensional coordinates to form a bitmap. For example, the pixel in the first row and in the first column of the bitmap image 650 can be presented as cos (θ1+θ1), and so on, the pixel matrix of the bitmap image 650 can be represented as matrix 630:

$$[ \begin{matrix}cos θ1 + θ 1 & cos θ1 + θ2 & cos θ1 + θ3 & cos θ1 + θ4 \\ cos θ2 + θ1 & cos θ2 + θ2 & cos θ2 + θ3 & cos θ2 + θ4 \\ cos θ3 + θ1 & cos θ3 + θ2 & cos θ3 + θ3 & cos θ3 + θ4 \\ cos θ4 + θ 1 & cos θ4 + θ2 & cos θ4 + θ3 & cos θ4 + θ4\end{matrix} ]$$

In some embodiments, through conversion 640, each element in the matrix 630 can be adjusted within the range of [0, 255], to seem like an image. Such image may be called bitmap image 650. In some embodiments, the pixel matrix 630 is represented as a chroma-luminance image, which may also be called bitmap image 650.

In some embodiments, conversion 660 shows converting the two-dimensional coordinates 610 into a bitmap image 690. The conversion 660 can be performed using the sine of the difference between angle values of each pair of the two-dimensional coordinates to form a bitmap. For example, the pixel in the first row and in the first column of the bitmap image 690 may be presented as sin (θ1−θ1), and so on, and the pixel matrix of the bitmap image 690 may be represented as a matrix 670:

$$[ \begin{matrix}sin θ1 - θ1 & sin θ1 - θ2 & sin θ1 - θ3 & sin θ1 - θ4 \\ sin θ2 - θ1 & sin θ2 - θ2 & sin θ2 - θ3 & sin θ2 - θ4 \\ sin θ3 - θ1 & sin θ3 - θ2 & sin θ3 - θ3 & sin θ3 - θ4 \\ sin θ4 - θ1 & sin θ4 - θ2 & sin θ4 - θ3 & sin θ4 - θ4\end{matrix} ]$$

In some embodiments, through conversion 680, each element of the matrix 670 can be adjusted within the range of [0, 255], to seem like an image. Such image may be called bitmap image 690. In some embodiments, the pixel matrix 670 is represented as a chroma-luminance image, which may also be called bitmap image 690. In this way, the one-dimensional time series data of the industrial network packets can be converted into two-dimensional image data, and then, the deep learning model after model training can be used to detect an abnormality in the industrial network to bring into full play the advantages of the deep learning model in image classification and recognition.

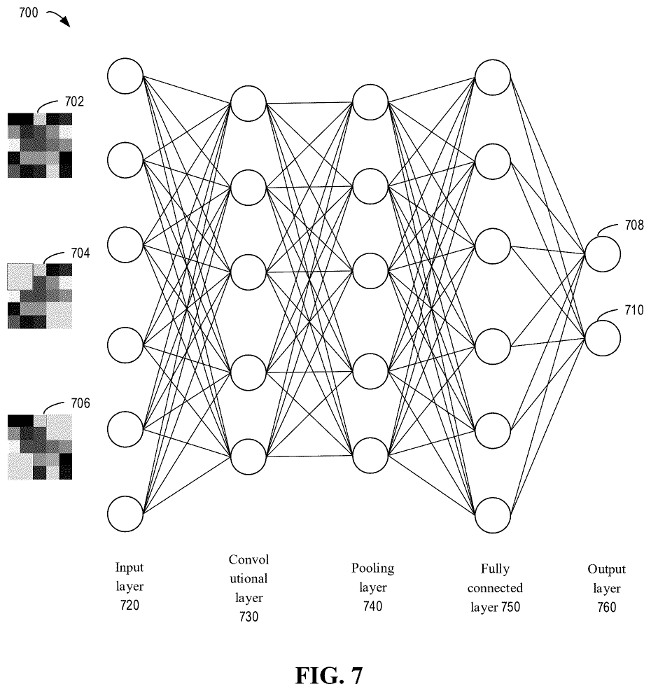

FIG. 7 illustrates a schematic diagram of an internal structure 700 of an anomaly detection model according to example implementations of the present disclosure. As shown therein, the anomaly detection model 120 may include an input layer 720, a convolutional layer 730, a pooling layer 740, a fully connected layer 750 and an output layer 760.

The input layer 720 may include a plurality of perceptrons (e.g. 6 perceptrons). Those perceptrons can take in input bitmap images, for example, a bitmap image 702, a bitmap image 704 and a bitmap image 706. In some embodiments, the input layer 720 may take in the input bitmap images in the manner of multiple channels. For example, there are three channels R, G and B in the RGB system, or there are three channels Y, U and V in the YUV system. It would be appreciated that the input layer 720 shown in FIG. 7 is provided only as an example, which may include more nodes and channels in practice.

The convolutional layer 730 can be used to extract features of a bitmap image. By way of example, the convolutional layer 730 may include a plurality of convolution kernels for extracting different features. It would be appreciated that the convolutional layer 730 is not limited to one layer as shown, and the number of convolutional layers may be set as required. The functionality of all the convolutional layers is to map original data into a hidden layer feature space to extract features. The number of convolutional layers is related to the user needs, computing power, model accuracy and the like, and therefore could be adjusted as required.

The anomaly detection model 120 may also include a fully connected layer 750. In the fully connected layer, the learned feature representation is mapped to a label space, i.e., the fully connected layer can integrate features extracted by the convolutional layer, which may be regarded as purifying features, to output them to a subsequent classifier. The anomaly detection model 120 may include more fully connected layers, which is related to the user needs, computing power, model accuracy and the like, and therefore, the number of fully connected layer could be adjusted as required.

In some embodiments, an activation function and a pooling layer 740 may also be included between the fully connected layer and the convolutional layer. The activation function which may be a nonlinear function is used for neurons output by the convolutional layer 730 and the fully connected layer 750, thereby introducing non-linear factors to the neurons, making the expressive power of the network more robust, and approximating almost any function.

In some embodiments, the pooling layer can reduce sensitivity of the convolutional layer to the target position, reduce the dimensionality of the feature space, and increase the computing speed of the anomaly detection model, to prevent the anomaly detection model from learning noise and avoid overfitting. The anomaly detection model 120 may also include an output layer 760. The output layer 760 may be a binary classifier. That is, the output layer 760 can output a probability 708 that a packet in the industrial network is normal and/or a probability 710 that the packet is abnormal.

In some embodiments, in a plurality of packets in the industrial network, a plurality of normal packets is labeled as a plurality of positive samples, and the plurality of positive samples is used to generate a corresponding bitmap image set (also referred to as positive sample set). In some embodiments, in a plurality of packets in the industrial network, a plurality of abnormal packets is labeled as a plurality of negative samples, and the plurality of negative samples is used to generate a corresponding bitmap image set (also referred to as negative sample set). In some embodiments, the positive sample set and the negative sample set may be used to train the deep learning model, and the trained deep learning model is determined as an anomaly detection model.

In some embodiments, the convolutional layer (e.g. the convolutional layer 730) may be used to generate a feature vector set (also referred to as first vector set) representing a plurality of normal packets. In some embodiments, the convolutional layer (e.g. the convolutional layer 730) may be used to represent a feature vector set (also referred to as second vector set) representing a plurality of abnormal packets. In some embodiments, based on the feature vector set representing a plurality of normal packets and the feature vector set representing a plurality of abnormal packets, the fully connected layer may be used to predict a probability set (also referred to as first probability set) as to whether a plurality of packets are normal.

In some embodiments, based on the feature vector set representing a plurality of normal packets and the feature vector set representing a plurality of abnormal packets, the fully connected layer may be used to predict a probability set (also called as second probability set) as to whether a plurality of packets are abnormal. In some embodiments, based on the feature vector set representing a plurality of normal packets and the feature vector set representing a plurality of abnormal packets, a combination of one or more of the fully connected layer, the pooling layer and the output layer may be used to predict a probability set as to whether a plurality of packets is normal.

In some embodiments, a predicted loss can be computed using a predicted result and a labelled correct result. In some embodiments, the parameters of the anomaly detection model 120 can be adjusted to reduce the predicted loss, and the adjusted parameters are determined as updated parameters of the optimized anomaly detection model 120. In some embodiments, a normality threshold may be set to determine whether a packet is normal. For example, a value of the normality threshold (also referred to as second threshold) may be determined, and in the case, if a probability indicating that a packet is normal is greater than the normality threshold, the packet can be regarded as normal.

In some embodiments, an abnormality threshold may be set to determine whether a packet is abnormal. For example, a value of the abnormality threshold (also referred to as third threshold) may be set, and in the case, if a probability indicating that a packet is abnormal is greater than the abnormality threshold, the packet can be regarded as abnormal. In some embodiments, abnormality in the industrial network may include repeatedly sending a normal packet, leading to network congestion. The abnormality in the industrial network may also include forging a packet for sending a false instruction or false data, interfering with the operation of the servers and the industrial devices.

The abnormality in the industrial network may include tampering with a content of a normal packet, causing the originally normal packet to be abnormal, or causing a payload, a destination, a port number and the like, of the packet to be wrong. The abnormality in the industrial network may also include sending requests at a frequency exceeding a normal value, causing the industrial devices, sensors or the like to not work properly due to frequent requests. In would be appreciated that the abnormality in the industrial network may also include other abnormal situations, such as illegally monitoring the network and the like, details of which are omitted herein for brevity.

In some embodiments, if it is determined that a packet is abnormal, an alarm can be sent. For example, an alarm indicating information such as a type, a time and the like, of an abnormality is sent to an operator, an administrator, a client and the like. In some embodiments, the administrator may provide a feedback on the alarm, for example, a feedback about whether the alarm is correct or wrong. The feedback may be divided more finely, for example, which may reflect some parts in the alarm are correct while some others are wrong. For example, it is fed back that an abnormality indeed occurs but the type of the abnormality is wrong. For another example, it is fed back that an abnormality indeed occurs but the type of the abnormality is wrong, and simultaneously a correct type of the abnormality is provided.

In some embodiments, based on the content fed back by the operator or administrator, the positive sample set 170 and the negative sample set 180 are further updated to optimize the performance of the anomaly detection model 120 and improve the accuracy of the anomaly detection model 120.

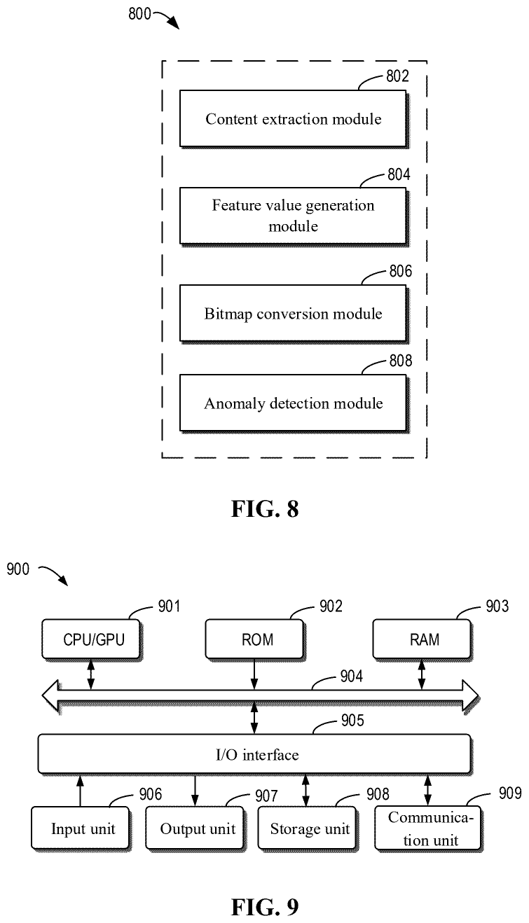

FIG. 8 illustrates a block diagram of an apparatus 800 for anomaly detection in an industrial network according to example implementations of the present disclosure. As shown therein, the apparatus 800 includes a content extraction module 802 configured to extract contents of a plurality of fields in a plurality of packets in an industrial network, wherein the plurality of packets is generated based on data collected from a sensor. The apparatus 800 further includes a feature value generation module 804 configured to generate, based on the extracted contents of the plurality of fields, a plurality of feature values corresponding to the plurality of packets, wherein the contents at least include an industrial protocol identifier and an industrial message type. The apparatus 800 further includes a bitmap conversion module 806 configured to convert a time series representing the plurality of feature values and a plurality of moments corresponding to the plurality of feature values into a bitmap image. The apparatus 800 further includes an anomaly detection module 808 configured to detect an abnormality in the industrial network based on the bitmap image. The apparatus 800 further include other modules to implement steps of the method 300 according to embodiments of the present disclosure.

In some embodiments, the apparatus 800 includes an iterative execution module configured to iteratively execute the following steps until a predetermined condition is met: determining a second packet in the plurality of packets in the industrial network, wherein the second packet is different from the first packet; weighting contents of a plurality of fields in the second packet to generate a second weighted value; and normalizing the second weighted value to generate a second feature value, wherein the predetermined condition includes that a number of a plurality of feature values generated reaches a predetermined first threshold.

In some embodiments, the apparatus 800 may further include a training module configured to: label a plurality of training bitmap images corresponding to normal packets in a plurality of training packets as a positive sample set; and label a plurality of training bitmap images corresponding to abnormal packets in the plurality of training packets as a negative sample set; and training the anomaly detection model using the positive sample set and the negative sample set.

In some embodiments, the apparatus 800 may further include an abnormality determining module configured to: determine an abnormal probability indicating that a packet in the industrial network is abnormal, or a normal probability indicating a packet is normal; in response to the abnormal probability being greater than a predetermined second threshold, determine that the packet is normal; or in response to the normal probability being greater than a predetermined third threshold, determine the packet is normal.

In some embodiments, the apparatus 800 may further include an alarm sending module configured to: in response to detecting at least one abnormality, send an alarm indicating the at least one abnormality. In some embodiments, the apparatus 800 may further include a feedback acquisition module configured to acquire a feedback on the alarm. In some embodiments, the apparatus 800 may also include a retraining module configured to retrain the anomaly detection model based on the feedback.

It would be appreciated that the apparatus 800 according to the present disclosure can attain at least one of the advantages of the method 300 and the processes 400 through 600 as described above. For example, the apparatus 800 can provide anomaly detection specific to industrial networks and can specifically support industrial protocols. For another example, the apparatus can identify more easily and more quickly an abnormality occurring in an industrial network environment, and improve the reliability required by the industrial networks.

FIG. 9 is a block diagram of a device 900 according to some embodiments of the present disclosure. The device 900 may be a device or apparatus as described above. As shown therein, the device 900 includes a central processing unit and/or a graphics processing unit (CPU/GPU) 901, which can perform various appropriate acts and processing, based on computer program instructions stored in a read-only memory (ROM) 902 or computer program instructions loaded from a storage unit 908 to a random access memory (RAM) 903. The RAM 903 stores therein various programs and data required for operations of the device 9000. The CPU/GPU 901, the ROM 902 and the RAM 903 are connected via a bus 904 with one another. Although not shown in FIG. 9, the apparatus 900 may also include a coprocessor.

The following components in the device 900 are connected to the I/O interface 905: an input unit 906 such as a keyboard, a mouse and the like; an output unit 907 including various kinds of displays and a loudspeaker, etc.; a storage unit 908 including a magnetic disk, an optical disk, and etc.; a communication unit 909 including a network card, a modem, and a wireless communication transceiver, etc. The communication unit 909 allows the device 900 to exchange information/data with other devices through a computer network such as the Internet and/or various kinds of telecommunications networks.

Various methods or processes described above may be executed by the CPU/GPU 901. For example, in some embodiments, the method can be implemented as a computer software program that is tangibly included in a machine readable medium, e.g., the storage unit 908. In some embodiments, part or all of the computer programs may be loaded and/or mounted onto the device 900 via the ROM 902 and/or communication unit 909. When the computer program is loaded to the RAM 903 and executed by the CPU/GPU 901, one or more steps of the method or process as described above may be executed.

In some embodiments, the method and process as described above may be implemented as a computer program product. The computer program product may include a computer readable storage medium having computer readable program instructions thereon for implementing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

These computer readable program instructions may be provided to a processor unit of a general purpose computer, special purpose computer, or other programmable data processing device to produce a machine, such that the instructions, when executed via the processing unit of the computer or other programmable data processing device, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the function/act specified in the flowchart and/or block diagram block or blocks.

The computer readable program instructions may also be loaded onto a computer, other programmable data processing device, or other devices to cause a series of operational steps to be performed on the computer, other programmable devices or other device to produce a computer implemented process, such that the instructions which are executed on the computer, other programmable device, or other devices implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the figures. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for anomaly detection in an industrial network, comprising:
according to an industrial network protocol, extracting contents of a plurality of fields in a plurality of packets in the industrial network, wherein the plurality of packets is generated based on data collected from a sensor;
generating, based on the extracted contents of the plurality of fields, a plurality of feature values corresponding to the plurality of packets, wherein the contents at least comprise an industrial protocol identifier and an industrial message type;
converting a time series representing the plurality of feature values and a plurality of moments corresponding to the plurality of feature values into a bitmap image; and
detecting, based on the bitmap image, an abnormality in the industrial network.

2. The method of claim 1, wherein generating, based on the extracted contents of the plurality of fields, the plurality of feature values corresponding to the plurality of packets comprises:
determining a first packet in the plurality of packets in the industrial network;
weighting contents of a plurality of fields in the first packet to generate a first weighted value; and
normalizing the first weighted value to generate a first feature value.

3. The method of claim 2, further comprising iteratively executing the following steps until a predetermined condition is met:
determining a second packet in the plurality of packets in the industrial network, wherein the second packet is different from the first packet;
weighting contents of a plurality of fields in the second packet to generate a second weighted value; and
normalizing the second weighted value to generate a second feature value;
wherein the predetermined condition comprises that a number of the plurality of feature values generated reaches a predetermined first threshold.

4. The method of claim 1, wherein converting the time series representing the plurality of feature values and the plurality of moments corresponding to the plurality of feature values into the bitmap image comprises:
determining, based on the time series, a plurality of two-dimensional coordinates associated with the time series, wherein the plurality of two-dimensional coordinates comprises a plurality of angles representing the plurality of feature values, and a plurality of radii representing the plurality of moments; and
determining, based on the plurality of two-dimensional coordinates, the bitmap image.

5. The method of claim 4, wherein determining, based on the plurality of two-dimensional coordinates, the bitmap image comprises at least one of:
generating the bitmap image based on a cosine associated with sums between the plurality of two-dimensional coordinates; or
generating the bitmap image based on a sine associated with differences between the plurality of two-dimensional coordinates.

6. The method of claim 1, wherein an anomaly detection model detects an abnormality in the industrial network, the method further comprising:
labelling a plurality of training bitmap images corresponding to normal packets in a plurality of training packets as a positive sample set;
labelling a plurality of training bitmap images corresponding to abnormal packets in the plurality of training packets as a negative sample set; and
training the anomaly detection model using the positive sample set and the negative sample set.

7. The method of claim 6, wherein training the anomaly detection model using the positive sample set and the negative sample set comprises:
generating, based on the positive sample set, a first vector set using a convolutional layer of a deep learning model;
generating, based on the negative sample set, a second vector set using the convolutional layer of the deep learning model;
predicting, based on the first vector set and the second vector set, a first probability set representing that the plurality of training packets is normal and a second probability set representing that the plurality of packets is abnormal, using a fully connected layer of the deep learning model;
computing a predicted loss based on the first probability set and the second probability set; and
adjusting a plurality of parameters of the deep learning model to reduce the predicted loss.

8. The method of claim 1, further comprising:
determining an abnormal probability representing that a packet in the industrial network is abnormal or a normal probability representing that the packet is normal; and
in response to the abnormal probability being greater than a predetermined second threshold, determining that the packet is abnormal; or
in response to the normal probability being greater than a predetermined third threshold, determining that the packet is normal.

9. The method of claim 1, wherein the abnormality in the industrial network comprises at least one of the following items:
repeatedly sending a normal packet;
forging a packet not existing originally;
tampering with a content of a normal packet; or
sending requests at a frequency exceeding a normal value in the industrial network.

10. The method of claim 9, further comprising:
in response to detecting the at least one item of the abnormality, issuing an alarm indicating the at least one item of abnormality.

11. The method of claim 10, further comprising:
acquiring a feedback on the alarm, wherein the feedback comprises at least one of the following items:
the alarm is correct;
the alarm is wrong, and no abnormality occurs; and
the alarm is wrong, and an abnormality occurs.

12. The method of claim 11, further comprising:
retraining the anomaly detection model based on the feedback.

13. An apparatus for anomaly detection in an industrial network, comprising:
a content extraction module configured to extract, according to an industrial network protocol, contents of a plurality of fields in a plurality of packets in the industrial network, wherein the plurality of packets is generated based on data collected from a sensor;
a feature value generation module configured to generate, based on the extracted contents of the plurality of fields, a plurality of feature values corresponding to the plurality of packets, wherein the contents at least comprise an industrial protocol identifier and an industrial message type;
a bitmap conversion module configured to convert a time series representing the plurality of feature values and a plurality of moments corresponding to the plurality of feature values into a bitmap image; and
an anomaly detection module configured to detect, based on the bitmap image, an abnormality in the industrial network.

14. A system for an industrial network, comprising:
a sensor for collecting data of industrial devices in the industrial network; and
an electronic device for receiving the data from the sensor, the electronic device located in a cloud or an industrial site, the electronic device comprising:
a processor; and
a memory coupled to the processor, the processor having instructions stored therein, the instructions, when executed by the processor, causing the electronic device to implement the method of claim 1.

15. A computer readable storage medium having computer executable instructions stored thereon, wherein the computer executable instructions, when executed, cause a device to implement the method of claim 1.
